(19) United States
(12) Patent Application Publication
(10) Pub. No.: US 2014/0270189 A1
(43) Pub. Date: Sep. 18, 2014

(54) IMPULSE RESPONSE APPROXIMATION METHODS AND RELATED SYSTEMS

(71) Applicant: Beats Electronics, LLC, Santa Monica, CA (US)

(72) Inventors: Joshua Atkins, Pacific Palisades, CA (US); Adam Strauss, Santa Monica, CA (US); Chen Zhang, Los Angeles, CA (US)

(73) Assignee: Beats Electronics, LLC, Santa Monica, CA (US)

(21) Appl. No.: 14/217,065

(22) Filed: Mar. 17, 2014

Related U.S. Application Data
(60) Provisional application No. 61/799,977, filed on Mar. 15, 2013.

(51) Int. Cl. H04S 5/00

(52) U.S. Cl. CPC H04S 5/00
USPC 381/17

(57) ABSTRACT

Systems and methods for achieving approximate convolution using partitioned truncated singular value decomposition filtering for each of monaural rendering and binaural rendering are disclosed herein.

### RELATED APPLICATIONS

This application claims the benefit of and priority to U.S. Patent Application No. 61/799,977, filed Mar. 15, 2013, the contents of which patent application are hereby incorporated by reference as if recited in full herein for all purposes.

### BACKGROUND

This application, and the innovations and related subject matter disclosed herein, (collectively referred to as the “disclosure”) generally concern digital signal processing techniques and digital signal processors (DSPs) implementing such techniques. More particularly but not exclusively, approximated convolution techniques for simulating art impulse response, and DSPs implementing such techniques, are disclosed, with partitioned singular value decomposition (PTSVD) being but one example of such techniques. As an example, such techniques can provide a binaural rendering of a single audio channel. Other embodiments of disclosed techniques can provide a plurality of output renderings of a plurality of input channels, with an audio signal being but one particular example of such input signals. Disclosed convolution techniques can enjoy improved computational efficiency and can he more suited for real-time applications than prior convolution techniques. As well, such innovative convolution techniques can provide high-quality output renderings.

### SUMMARY

The innovations disclosed herein overcome many problems in the prior art and address the aforementioned as well as other needs. In some respects, the innovations disclosed herein are directed to methods for rendering one or more responses to one or more input signals using a selected convolution technique, and more particularly, hut not exclusively, to convolution techniques involving selected approximations to system response filters. Such techniques can allow a processing system to render one or more approximated system responses in real-time. As but one particular example, disclosed signal processing techniques can so render audio through a pair of headphones as to approximate a user's perception of audio output from a plurality of loudspeakers in any of a variety of environments (e.g., movie theaters, concert halls, night clubs, etc.). Disclosed signal processing techniques can also improve convergence rates, reduce computational overhead, and/or reduce memory requirements as compared to previously proposed techniques. Such improvements, in turn, can allow digital processors and other computing environments to have relatively lower power.

One or more filters for rendering a system response to an input signal can be defined. In some instances, such an impulse response filter has a filter length greater than 10⁴ samples.

As an example, an impulse response filter corresponding to a system's response to an input signal can be provided. The impulse response filter can be approximated as combination of a plurality of selected M input filter components, where each input filter component has a corresponding component length N, and a plurality of selected M output filter components, where each output filter component has a corresponding plurality of P output filter coefficients. Each subsequent output filter coefficient can be delayed by N samples from a previous output filter coefficient. The selected M input filter components and the selected M output filter components can define a truncated approximation of the impulse response filter corresponding to a sub-plurality of M highest-energy partitions of a gross plurality of P partitions of the impulse response filter. Art infinite-impulse response approximation to the truncated approximation of the impulse response filter can be provided.

In some instances, the impulse response filter can be approximated by identifying relative energy content among partitions of the impulse response filter by partitioning the impulse response filter and factoring the partitioned impulse response filter. For example, singular value decomposition procedure on the partitioned impulse response filter can be performed to define an N×N singular vector corresponding to the input filter components and a P×P singular vector corresponding to the output filter components. The singular vectors can be truncated. For example, the N×N singular vector cart be truncated to be of size N×M and the P×P singular vector can be truncated to be of size P×M. Stated differently, the sub-plurality of M output filters can be selected by truncating the P×P singular vector to be of size P×M.

In some instances, the input signal comprises an audio signal and the system response comprises first and second binaural output signals. As an example, the impulse response filter can include a filter from one input channel to two output channels. The plurality of M output filter components can form a first plurality of M output filter components corresponding to one of the two output channels. The impulse response filter can be further approximated by defining a second plurality of M output filters corresponding to the other of the two output channels.

As noted above, an infinite impulse response can be introduced to the approximation of the impulse response filter. For example, an infinite impulse response approximation to the input filter components and an infinite impulse response approximation to the output filter components can be introduced. An order of the infinite impulse response approximation to the input filters can differ from an order of the infinite impulse response approximation to the output filters.

As another example, a first infinite impulse response approximation to the first plurality of output filter components can be introduced. As well, a second infinite impulse response approximation to the second plurality of output filter components can be introduced, together with a third infinite impulse response approximation to the input filter components. In some instances, an order of the first infinite impulse response approximation differs from an order of the second infinite impulse response and an order of the third infinite impulse response order.

An error function can correspond to a difference between the impulse response filter and the truncated approximation of the impulse response filter. A value of the error function can correspond in part to a number of filter components in the gross plurality P of filter components and a number of filter components M in the sub-plurality of components.

During design of the input and the output filter components, a combination of N, M, an order of the infinite impulse response approximation to the input filter components, and an order of the infinite impulse response approximation to the output filter components can be selected to correspond to a selected error-minimization criterion. In context of one input channel and two output channels, a combination of N, M, an order of the first infinite impulse response approximation, an order of the second infinite impulse response approximation, and an order of the third infinite impulse response approximation can be selected to correspond to a selected error-minimization criterion.

A digital signal processor can have an input channel and an output channel. A plurality of M input filter components can correspond to the input channel. Each in the plurality of input filter components can have a corresponding length N, and the plurality of input filter components can be approximated by an IIR approximation having a corresponding input IIR order. A plurality of M output filter components can correspond to the output channel, each output filter component having a corresponding plurality of P output filter coefficients. Each subsequent output filter coefficient can be delayed by N samples from a previous output filter coefficient. Each of the plurality of output filter components can be approximated by an IIR approximation having a corresponding output IIR order. Each of the input filter components can be associated with a corresponding output filter component such that the filter components are arranged to render a system response y(n) front an input signal x(n) according to

$$y ( n ) = {\sum }_{p = 0}^{P - 1} {\sum }_{m = 0}^{M - 1} {v}_{m}^{p} {σ}_{m} {u}_{m}^{T} x ( n - pN ) .$$

Some digital signal processors have one output channel.

In other instances, the output channel is a first output channel r the plurality of M output filter components constitute a first plurality of M output filter components, and the IIR approximation of the first plurality of output filter components constitutes a first IIR approximation having a corresponding first output IIR order. Such a digital signal processor can also include a second output channel, a second plurality of M output filter components corresponding to the second output channel, and an IIR approximation of the second plurality of output filter components having a corresponding second output IIR order. Each of the input filter components can be associated with a corresponding output filter component in the first plurality of output filter components to render a first system response y₁(n) from an input signal x(n) according to

$${y}_{1} ( n ) = {\sum }_{p = 0}^{P - 1} {\sum }_{m = 0}^{M - 1} {v}_{m}^{p} {σ}_{m} {u}_{m}^{T} x ( n - pN ) .$$

Each of the input filters can also be associated with a corresponding output filter in the second plurality of output filter components to render a second system response y₂(n) from the input signal according to

$${Y}_{2} ( n ) = {\sum }_{p = 0}^{P - 1} {\sum }_{m = 0}^{M - 1} {z}_{m}^{p} {σ}_{m} {u}_{m}^{T} x ( n - pN ) .$$

In some digital signal processors, the input IIR order differs from the output IIR order. For example, in a digital signal processor having two output channels, the input IIR order can differ from either or both of the first output IIR order and the second output IIR order.

The foregoing and other features and advantages will become more apparent from the following detailed description, which proceeds with reference to the accompanying drawings.

### BRIEF DESCRIPTION OF THE DRAWINGS

Unless specified otherwise, the accompanying drawings illustrate aspects of the innovative subject matter described herein. Referring to the drawings, wherein like numerals refer to like parts throughout the several views and this specification, several embodiments of presently disclosed principles are illustrated by way of example, and not by way of limitation, wherein:

FIGS. 1A and 1B show a graph showing a typical room impulse response and a PTSVD approximation error thereof, according to one embodiment.

FIG. 2 illustrates the structure of a PTSVD filter according to one embodiment.

FIG. 3 illustrates the IIR approximation error for four uₘ and vₘ filters for the reverberation filter of FIG. 1, according to one embodiment.

FIGS. 4A, 4B, 4C, and 4D show graphs related to the complexity and memory usage for a PTSVD approximation according to one embodiment.

FIGS. 5A and 5B illustrate the error in a PTSVD approximation according to one embodiment.

FIG. 6 illustrates the structure of a 1-input, 2-output PTSVD filter according to one embodiment,

FIG. 7 illustrates a graphical comparison of a PTSVD approximation and an original filter, according to one embodiment.

FIG. 8 illustrates a graphical comparison of a PTSVD IIR approximation and an original filter, according to one embodiment.

### DETAILED DESCRIPTION

The following describes various innovative principles related to signal processing by way of reference to specific examples of techniques for rendering one or more system responses to one or more input signals, and more particularly but not exclusively, to techniques for rendering such response signals in real time. Nonetheless, one or more of the disclosed principles can be incorporated in various other filters to achieve any of a variety of corresponding system characteristics. Techniques and systems described in relation to particular configurations, applications, or uses, are merely examples of techniques and systems incorporating one or more of the innovative principles disclosed herein and are used to illustrate one or more innovative aspects of the disclosed principles.

Thus, filters and systems having attributes that are different from those specific examples discussed herein can embody one or more of the innovative principles, and can be used in applications not described herein detail, for example, in “hands-free” automobile communication systems, in aviation communication systems, in conference room speaker phones, in auditorium sound systems, etc. Accordingly, such alternative embodiments also fall within the scope of this disclosure.

### Overview

The description that follows describes, illustrates and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

### I. Monaural Rendering

This document describes systems and methods for achieving approximate convolution using partitioned truncated singular value decomposition filtering for monaural rendering and/or binaural rendering. In many signal processing applications it is necessary to perform large convolutions in real-time. For systems where an exact convolution is too complex, Applicants show herein an approximation using a partitioned truncated singular value decomposition (PTSVD) filter. In this technique, the filter is first partitioned into P segments of length N, the singular value decomposition is performed on the N×P matrix, and only the largest M singular values and associated vectors are used to reconstruct the filter. Applicants show herein an efficient real-time implementation utilizing a filter bank and tapped delay line and then further simplify the structure utilizing an IIR model. Finally, Applicants show herein an application of the method in a simulated reverberation engine and compare complexity and memory load to state of the art methods.

Traditional audio signal processing problems both in telecommunications and multimedia often rely on FIR filter models, e.g. for the room impulse response, that can be very large and, consequently, difficult to implement in practice. State of the art techniques for implementing these filters in real-time systems use the overlap-add or overlap-save methods and partitioned frequency domain convolution to reduce complexity and delay. However, frequency domain techniques are inherently block based and introduce an amount of system latency. Alternative methods have been explored in certain application domains, such as using a perceptual model to remove certain time-frequency data from processing or subband decomposition of the impulse response. For short impulse responses (on the order of a few 100 FIR coefficients), IIR methods are attractive ways for reducing complexity, but these techniques fail for longer filters.

### 1. Introduction

This document describes an alternative idea, partitioned truncated singular value decomposition (PTSVD) filtering, where the impulse response is partitioned in time, factorized using the singular value decomposition (SVD), and then reconstructed using only the M singular vectors corresponding to the M largest singular values. This filtering technique was initially explored for the purpose of creating efficient versions of linear phase bandpass and lowpass FIR prototypes. The image processing community also has used the truncated SVD for 2D filter design.

In this document, Applicants provide additional analysis of the filtering technique described above by extending it to systems that are not guaranteed to be linear phase and analyzing the tradeoff in complexity, memory usage, and approximation error. In Section 3, Applicants describe a filter structure that takes advantage of the truncated SVD matrices and leads to an efficient implementation. Applicants also describe a further approximation that both reduces the memory footprint and the computational complexity using an IIR input and output filter. This filtering technique not only has the benefit of reduced memory and complexity over traditional methods, it is also delay-less since it does not require a block-based processing structure.

### Filter Approximation

Let h=[h(0)h(1) . . . h(L−1)] be an impulse response of length L. We can construct a N×P matrix H by partitioning h into P partitions of length N=L/P (and zero padding h if necessary so that it is of length P×N), H can then be factored using SVD as: H=USV^{H}, where (·)^{H} is the conjugate transpose, U and V are the N×N and P×P singular vectors which form a basis for the factorization, and S is a N×P matrix containing the singular values along its main diagonal. The singular values are assumed to be in descending order.

M^{th} order approximate filter, H_{M}, can be created by using only the M largest singular values in its reconstruction. This is done by truncating U and V to be of size N×M and P×M, respectively, and taking the M×M portion of S corresponding to the largest singular values. The approximate filter is then: H_{M}=U_{M}S_{M}V^{H}_{M} (hereinafter “Equation 1”). The error in our M^{th} order approximation is given as: e(M, N)=∥H−H_{M}∥₂, where ∥·∥2 is the entry-wise l2-norm. The use of the SVD guarantees that H_{M} is the rank-M reconstruction of H with the lowest error, e(M, N).

At this point, there are two free parameters, M and N, that determine the error in the approximation filter. FIG. 1 shows the error surface for a typical room impulse response. More specifically. FIG. 1a shows the impulse response for a typical room where RT60=500ms, and FIG. 1b shows the PTSVD approximation error. This example shows that there exist very low rank approximations of the original filter that achieve minimal error.

### 3. Efficient Filter Structure

Now, the discussion will focus on how the filter H_{M} generated in the last section can be implemented efficiently for real-time applications. First, Equation 1 is rewritten in an expanded form as Equation 2:

$$H = {[ \begin{matrix}{σ}_{0} {u}_{0} \\ {σ}_{1} {u}_{1} \\ … \\ {σ}_{M - 1} {u}_{M - 1}\end{matrix} ]}^{T} [ \begin{matrix}{v}_{0}^{0} & {v}_{0}^{1} & … & {v}_{0}^{P - 1} \\ {v}_{1}^{0} & {v}_{1}^{1} & … & {v}_{1}^{P - 1} \\ ⋮ & ⋮ & ⋱ & ⋮ \\ {v}_{M - 1}^{0} & {v}_{M - 1}^{1} & … & {v}_{M - 1}^{P - 1}\end{matrix} ]$$

In Equation 2, σₘ are the singular values from S_{M} and uₘ are the length N singular vectors of U_{M}. Recognizing that the P columns of H_{M} are the time-partitioned version of the filter, each delayed. N samples from the last, a filter implementation of H can be written as Equation 3:

$$y ( n ) = {\sum }_{p = 0}^{P - 1} {\sum }_{m = 0}^{M - 1} {v}_{m}^{p} {σ}_{m} {u}_{m}^{T} x ( n - pN )$$

In the above equation, x(n) is the vector of the last N samples of x at time step n. FIG. 2 shows this PTSVD filter structure, which resembles a filter-bank analysis section with M length N filters each followed by a tapped delay line of length P. Note that this filter structure achieves a lower complexity implementation of the FIR filter when a low rank approximation is used, but the memory usage is increased significantly to store the M delay lines (each the same length as the original filter). This will limit system performance in real applications where memory bandwidth is an issue.

The representation in FIG. 2 can be further optimized by modeling the input and output filters using an IIR approximation. This reduces multiply-add instructions, but also reduces memory storage significantly since the M length L delay lines do not need to be stored due to the recursive IIR structure. FIG. 3 shows approximation error in the first 4 uₘ and vₘ filters for the reverberation filter shown in FIG. 1 using a partition size of N=53 and 9^{th} order for the uₘ filters and the 41^{st} order for the vₘ filters. The IIR approximations were designed using invfreqz in MATLAB, which uses an equation-error method for an initial coefficient guess followed by an iterative scheme to minimize the solution-error.

### 4. Complexity Analysis

The PTSVD filter structure discussed above, in its initial form, requires M×(N+P) multiply-add instructions per input sample and memory of size M×(N+P+L)+N. A conventional time-domain FIR filter requires L operations per input sample and 2 L variables Implementing the FIR filter with partitioned convolution (partition size=N) greatly reduces complexity: 4αlog2(2 N)+4P+1 instructions per sample and 4 PN variables for overlap-add, where α is a platform specific FFT cost.

FIG. 4 shows the complexity and memory of the frequency domain partitioned convolution (in dashed lines) and the PTSVD at various rank-M approximations (N=128 is assumed). These are shown as a percent of the complexity and memory of the time-domain FIR implementation, so values above 100% provide no savings. FIGS. 4a and 4b are for time domain PTSVD and FIGS. 4c and 4d are for PTSVD using an IIR model of the filters (Q_{U}+Q_{V}=60 assumed). For nearly all filter lengths, the PTSVD approach is lower complexity than a traditional FIR, showing significant benefits when the filter length becomes large. Further, as can be seen from FIG. 4, the partitioned convolution (dashed line) is more efficient than the PTSVD for filters less than 10,000 coefficients and M>2.

As mentioned in Section 3, the PTSVD structure becomes very efficient when the input and output filters are modeled with an IIR approximation. This results in a structure with 2.5 M(Q_{U}+Q_{V}) instructions and 3.5 M(O_{U}+Q_{V}) variables, where Q_{U} and Q_{V} are the IIR approximation orders of the U and V filters (direct form H transpose using second order sections is assumed). The complexity and memory of the PTSVD-IIR are shown in FIG. 4 (Q_{U}+Q_{V}=60 is assumed). FIG. 4 shows that the technique described herein can both significantly save memory usage as well as complexity for filters of length 1,000 coefficients or more.

Note that the graphs in FIG. 4 have fixed N=128 and Q_{U}+Q_{V}=60 and thus do not show the full picture. However, they provide a reasonable view of where the technique disclosed herein becomes useful in real systems where 128 samples is a common frame size and Q_{U}+Q_{V}=60 is a typical combined IIR approximation order above which the error becomes negligible.

Furthermore, the PTSVD filter structure also permits other models which may achieve better performance in certain contexts, such as using frequency domain processing for the uₘ or vₘ filters or using an IIR model for only one section, or using varying IIR approximation orders for each uₘ or vₘ, which are not analyzed in this work.

### 5. Simulation

Since the N, M, Q_{U}, and Q_{V} are all integer valued, it is possible to calculate the finite set of (nᵢ, mᵢ, quᵢ, qvᵢ) that meet a given memory and complexity requirement on a particular platform. Although the choice of error metric should be application dependent (e.g., a spectro-temporal metric for audio applications), as a simple choice, the point that results in the lowest l₂ approximation error can be chosen.

As an example, the impulse response from FIG. 1 is now approximated by the PTSVD-IIR technique, A search over possible N, M, Q_{U}, and Q_{V} with a maximum complexity of 500 operations per sample and memory usage of 1000 variables was performed. The resulting filter design used the parameters N=53, M=4, Q_{U}=9, and Q_{V}=41 resulting in a complexity of 500 operations per sample and memory usage of 700 variables. FIG. 5a shows the error for the PTSVD filter using this approximation and FIG. 5b shows the error for the PTSVD-IIR filter, The resulting U and V filters and their IIR approximations are shown in FIG. 3. For reference, the time domain FIR version of this filter requires 20,315 operations per sample and 40,630 variables and a partitioned convolution with N=53 requires 1,583 operations per sample and 81,408 variables (assuming α=1.7). This is a 98% improvement over regular FIR filtering and 68% improvement over partitioned convolution in addition to the benefit of no block delay (53 samples).

### 6. Conclusions

The above discussion describes how a conventional convolution can be approximated with a lower complexity rank-M filter that is optimal in the l₂ sense. Further, an efficient filter structure for the approximation and an IIR implementation that delivers low-error results with minimal complexity and memory usage for real-time systems have been described herein.

The technique described herein can he applied in other areas, including alternative low-rank approximations (as opposed to the SVD), joint spatio-temporal filter design for spatial audio rendering and beamforming, and adaptive implementation for applications such as echo cancelation. Adaptations of the PTSVD filtering structure, such as varying IIR approximation orders for each um and vm filter, frequency domain SVD analysis, and combination with subband methods, may also be accomplished.

### II. Binaural Rendering

In conventional binaural rendering, a pair of head-related impulse responses (HRIR), measured front source direction to left and right ears, is convolved with a source Signal to create the impression of a virtual 3D sound source when played on headphones. It is well known that using HRIRs measured in a real room, which includes a natural reverberant decay, increases the externalization and realism of the simulation. However, the HRIR filter length in even a small room can be many thousands of taps leading to computational complexity issues in real world implementations. Described herein is a new technique, partitioned truncated singular value decomposition (PTSVD) filtering, for approximating the convolution by partitioning the HRIR filters in time, performing a singular value decomposition on the matrix of filter partitions, and choosing the M singular-vectors corresponding to the M largest singular values to reconstruct the HRIR filters. The following disclosure will show how this can be implemented in an efficient filter-bank type structure with M tapped delay lines for real-time application. The following disclosure will also show how improvements to the technique, such as modeling the direct path HRIR separately can lead to improved rendering at minimal computational load.

### 1. Introduction

The acoustic information of a sound source's location in three-dimensional space can be simulated over headphones through the use of the left and right binaural head-related impulse responses (HRIR). These HRIRs correspond to the impulse responses from the source to the subject's left and right ears as measured in an anechoic setting. To realistically recreate the sound of a specific room or increase the amount of externalization of a source, the binaural room impulse responses (BM) are used. These responses are typically in the range of 10000 to 100000 taps long at 44 kHz sampling rate for medium sized rooms and thus are complex to implement in real-time DSP systems.

Many techniques have been proposed to reduce the complexity of the convolution operation, the most notable being the overlap-save and overlap-add methods with variable block size. These techniques reduce complexity by partitioning the input data and filter into small blocks and use the FFT to perform the convolution in the frequency domain. Yet other techniques focus on perceptual metrics to reduce complexity. This disclosure shows how a technique developed for approximating the convolution, the PTSVD, can be used to implement binaural filters efficiently.

### 2. Background

This section recaps some of the findings from the monaural rendering discussion above, Let h=[h(0)h(1) . . . h(L−1)] be an impulse response of length L. A N×P matrix H can be constructed by partitioning h into P partitions of length N=[L/P] (and zero padding h if necessary so that it is of length P×N). H can then be factored using the singular value decomposition (SVD) as H=USV^{H} (Equation 1 from above), where (·)^{H} is the conjugate transpose, U and V are the N×N and P×P singular vectors, respectively, and S is a N×P matrix containing the singular values along its main diagonal in descending order. An M^{th} order approximate filter. H_{M}, can be created by using only the M largest singular values in its reconstruction, resulting in Equation 2 from above:

$${H}_{M} = {U}_{M} {S}_{M} {V}_{M}^{H} = {[ \begin{matrix}{σ}_{0} {u}_{0} \\ {σ}_{1} {u}_{1} \\ … \\ {σ}_{M - 1} {u}_{M - 1}\end{matrix} ]}^{T} [ \begin{matrix}{v}_{0}^{0} & {v}_{0}^{1} & … & {v}_{0}^{P - 1} \\ {v}_{1}^{0} & {v}_{1}^{1} & … & {v}_{1}^{P - 1} \\ ⋮ & ⋮ & ⋱ & ⋮ \\ {v}_{M - 1}^{0} & {v}_{M - 1}^{1} & … & {v}_{M - 1}^{P - 1}\end{matrix} ]$$

In Equation 2, σₘ are the singular values from S_{M} and uₘ are the length N singular vectors of U_{M}, The use of the SVD guarantees that H_{M} is the rank-M reconstruction of H with the lowest error, e(M,N)=∥H−H_{M}∥_{F}, where ∥·∥_{F} is the Frobenius norm. This technique has been explored for creating linear phase bandpass and lowpass FIR filters that approximate a prototype filter response.

The P columns of H_{M} are the time-partitioned version of the filter, each delayed N samples from the last, thus a filter implementation of H can be written as Equation 3 from above:

$$y ( n ) = {\sum }_{p = 0}^{P - 1} {\sum }_{m = 0}^{M - 1} {v}_{m}^{p} {σ}_{m} {u}_{m}^{T} x ( n - pN )$$

In Equation 3, x(n) is the vector of the last N samples of x at time step n. FIG. 1 shows this filter structure, which resembles a filter-bank analysis section with M length N filters each followed by a tapped delay line of length P. The representation can be further optimized by modeling the input and output filters using an IIR approximation. This not only reduces multiply-add instructions, but also reduces memory storage significantly since the M length L delay lines do not need to be stored due to its recursive IIR structure.

### 3. Binaural Applications

The PTSVD filter proposed in the previous section and in the monaural discussion above can he made even more efficient when used in a binaural processing application where a single channel goes into the processing structure (the signal from a specific source direction) and a pair of left and right signals exits. In this case, the input, uₘ, filters can be shared and separate output filters, vₘ, can be created for the left and right channels.

This can be easily done by cascading the left and right impulse responses, hₗ and hᵣ, such that h=[hₗ(0)hₗ(1) . . . hₗ(L−1)hᵣ(0)ᵣ(1) . . . hᵣ(L−1)]. Then, after performing the SVD and truncation in Equations 1 and 2, the approximate filters will be in the matrix H_{M} as

$${H}_{M} = [ {H}_{1} \vert {H}_{r} ] = {[ \begin{matrix}{σ}_{0} {u}_{0} \\ {σ}_{1} {u}_{1} \\ … \\ {σ}_{M - 1} {u}_{M - 1}\end{matrix} ]}^{T} [ \begin{matrix}{v}_{0}^{0} & {v}_{0}^{1} & … & {v}_{0}^{P - 1} \\ {v}_{1}^{0} & {v}_{1}^{1} & … & {v}_{1}^{P - 1} \\ ⋮ & ⋮ & ⋱ & ⋮ \\ {v}_{M - 1}^{0} & {v}_{M - 1}^{1} & … & {v}_{M - 1}^{P - 1}\end{matrix} \vert \begin{matrix}{z}_{0}^{0} & {z}_{0}^{1} & … & {z}_{0}^{P - 1} \\ {z}_{1}^{0} & {z}_{1}^{1} & … & {z}_{1}^{P - 1} \\ ⋮ & ⋮ & ⋱ & ⋮ \\ {z}_{M - 1}^{0} & {z}_{M - 1}^{1} & … & {z}_{M - 1}^{P - 1}\end{matrix} ] .$$

The filtered outputs for the binaural left and right channels can then be expressed as Equations 4 and 5:

$$\begin{matrix}{y}_{l} ( n ) = {\sum }_{p = 0}^{P - 1} {\sum }_{m = 0}^{M - 1} {v}_{m}^{p} {σ}_{m} {u}_{m}^{T} x ( n - pN ) & ( 4 ) \\ {y}_{r} ( n ) = {\sum }_{p = 0}^{P - 1} {\sum }_{m = 0}^{M - 1} {z}_{m}^{p} {σ}_{m} {u}_{m}^{T} x ( n - pN ) & ( 5 )\end{matrix}$$

The structure of the binaural PTSVD filter is shown in FIG. 6.

Table 1 below shows the complexity, memory usage, and system latency for the proposed binaural method, partitioned convolution using overlap-add, FIR based convolution, and a FFT based convolution. It is assumed that the overlap-add structure uses a single FFT for the input and one IFFT for each output to minimize complexity. In the IIR version of the PTSVD technique, the output filters are modeled as Qᵥ and Qᵤ order filters.

TABLE 1
Comparison of methods for binaural rendering of a single source.

| | Complexity | Memory | Delay |
|---|---|---|---|
| Method | (MAC/samp) | (vars) | (samp) |
| FIR | 2L | 4L | 0 |
| Partitioned | 6αlog₂(2N) + 8P + 2 | 8L | N |
| Convolution | | | |
| PTSVD-FIR | M(N + 2P) | M(N + 2P + 2L) + N | 0 |
| PTSVD-IIR | 2.5M(Qᵤ + 2Qᵥ) | 3.5M(Qᵤ+ 2Qᵥ) | 0 |

### 4. Simulations

A room with an impulse response of 200 ms (RT60) was measured with a KEMAR using 0.5 in microphones at the entrance to the simulated ear canals. FIG. 7 shows the spectrogram of the filter along with the approximate PTSVD filter using N=32 and M=3. The PTSVD version shows a speedup of approximately 1.3× when using FIR filters with no system latency (partitioned convolution has 32 sample latency). Using the same N and M and a Qᵤ and Qᵥ of 25th order, the u and v filters with IIR topologies can be approximated. The IIR approximation is shown in FIG. 8 and has a speedup of 3.8× over the partitioned convolution.

FIGS. 7 and 8 are indicative of the performance of the binaural PTSVD FIR and IIR variants, but better results can be found by searching the space of N, M, Qᵤ, and Qᵥ for a filter that minimizes a given error function (such as l₂-norm).

### 5. Conclusions

The binaural PTSVD described herein allows designers of binaural processing systems (e.g. for gaming, training, or multimedia applications) an additional level of DSP flexibility to deal with complexity issues that arise in real-time systems. This disclosure has shown how this technique can scale from an exact convolution to a low-complexity approximation of the convolution via choice of rank, M, and partition size, N. Modeling the PTSVD filters using DR filters both reduces the system latency. complexity. and memory usage significantly. Listening tests comparing the original and approximate filters along with an optimization technique using a genetic algorithm to find the best choose of N, M, Qᵤ, and Qᵥ for a given application may also he shown using the above techniques.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower ” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” arid “or.” Moreover, all patent and non-patent literature cited herein is hereby incorporated by references in its entirety for all purposes.

The previous description of the disclosed embodiments is provided to enable any person skilled in the art to make or use the disclosed innovations. Those of ordinary skill in the art will appreciate that the exemplary embodiments disclosed herein can be adapted to various configurations and/or uses without departing from the disclosed principles. For example, the principles described above in connection with any particular example can be combined with the principles described in connection with another example described herein. Various modifications to those embodiments will be readily apparent to those skilled in the art, and the generic principles defined herein may be applied to other embodiments without departing from the spirit or scope of this disclosure. Accordingly, this detailed description shall not be construed in a limiting sense, and following a review of this disclosure, those of ordinary skill in the art will appreciate the wide variety of filtering and computational techniques can be devised using the various concepts described herein.

Similarly, the presently claimed inventions are not intended to be limited to the embodiments shown herein, but are to be accorded the full scope consistent with the language of the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the features described and claimed herein. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

Thus, in view of the many possible embodiments to which the disclosed principles can be applied, we reserve to the right to claim any and all combinations of features described herein, including, for example, all that comes within the scope and spirit of the foregoing description and the combinations recited in the following claims.

We currently claim:

1. A method of defining one or more filters for rendering a system response to an input signal, the method comprising:
providing an impulse response filter corresponding to a system's response to an input signal;
approximating the impulse response filter as combination of a plurality of selected M input filter components, each input filter component having a corresponding component length N, and a plurality of selected M output filter components, each output filter component having a corresponding plurality of P output filter coefficients, each subsequent output filter coefficient being delayed by N samples from a previous output filter coefficient, wherein the selected M input filter components and the selected M output filter components define a truncated approximation of the impulse response filter corresponding to a sub-plurality of M highest-energy partitions of a gross plurality of P partitions of the impulse response filter.

2. A method according to claim 1, wherein the act of approximating the impulse response filter comprises identifying relative energy content among partitions of the impulse response filter by partitioning the impulse response filter and factoring the partitioned impulse response filter.

3. A method according to claim 2, wherein the act of approximating the impulse response filter comprises performing a singular value decomposition procedure on the partitioned impulse response filter to define an N×N singular vector corresponding to the input filter components and a P×P singular vector corresponding to the output filter components.

4. A method according to claim 3, wherein the act of approximating the impulse response filter further comprises truncating the N×N singular vector to be of size N×M and by truncating the P×P singular vector to be of size P×M.

5. A method according to claim 3, wherein the act of selecting a sub-plurality of M output filters comprises truncating the P×P singular vector to be of size P×M.

6. A method according to claim 1, wherein the impulse response filter comprises a filter from one input channel to two output channels, and wherein the plurality of M output filter components comprises a first plurality of M output filter components corresponding to corresponding to one of the two output channels, wherein the act of approximating the impulse response filter further comprises defining a second plurality of M output filters corresponding to the other of the two output channels.

7. A method according to claim 1, wherein the input signal comprises an audio signal and the system response comprises first and second binaural output signals.

8. A method according to claim 1, further comprising:
defining an error function corresponding to a difference between the impulse response filter and the truncated approximation of the impulse response filter.

9. A method according to claim 8, wherein a value of the error function corresponds in part to a number of filter components in the gross plurality P of filter components arid a number of filter components M in the sub-plurality of components.

10. A method according to claim 1, further comprising introducing an infinite impulse response approximation to the input filter components and an infinite impulse response approximation to the output filter components.

11. A method according to claim 10, wherein an order of the infinite impulse response approximation to the input filters differs from an order of the infinite impulse response approximation to the output filters.

12. A method according to claim 6, further comprising introducing a first infinite impulse response approximation to the first plurality of output filter components, introducing a second infinite impulse response approximation to the second plurality of output filter components, and introducing a third infinite impulse response approximation to the input filter components.

13. A method according to claim 12, wherein an order of the first infinite impulse response approximation differs from an order of the second infinite impulse response and an order of the third infinite impulse response order.

14. A method according to claim 1, wherein the impulse response filter has a filter length greater than 10⁴ samples.

15. A method according to claim 10, further comprising selecting a combination of N, M, an order of the infinite impulse response approximation to the input filter components, and an order of the infinite impulse response approximation to the output filter components corresponding to a selected error-minimization criterion.

16. A method according to claim 13, further comprising selecting a combination of N, M, an order of the first infinite impulse response approximation, an order of the second infinite impulse response approximation, and an order of the third infinite impulse response approximation.

17. A digital signal processor, comprising:
an input channel and an output channel;
a plurality of M input filter components corresponding to the input channel, each in the plurality of input filter components having a corresponding length N, wherein the plurality of input filter components are approximated by an IIR approximation having a corresponding input IIR order;
a plurality of M output filter components corresponding to the output channel, each output filter component having a corresponding plurality P output filter coefficients, wherein each subsequent output filter coefficient is delayed by N samples from a previous output filter coefficient; and
wherein each of the input filter components is associated with a corresponding output filter component such that the filter components are arranged to approximate an impulse and response and to render a system response y(n) from an input signal x(n) according to
$$y ( n ) = {\sum }_{p = 0}^{P - 1} {\sum }_{m = 0}^{M - 1} {v}_{m}^{p} {σ}_{m} {u}_{m}^{T} x ( n - pN ) .$$

18. A digital signal processor according to claim 17, wherein the plurality of output filter components
are approximated by an IIR approximation having a corresponding output IIR order.

19. A digital signal processor according to claim 17, wherein the output channel comprises one output channel.

20. A digital signal processor according to claim 17, wherein the output channel comprises a first output channel and the plurality of M output filter components comprises a first plurality of M output filter components, wherein the digital signal processor further comprises a second output channel, a second plurality of M output filter components corresponding to the second output channel.

21. A digital signal processor according to claim 20, wherein the first plurality of output filter components are approximated by a first IIR approximation having a corresponding first output IIR order, wherein the second plurality of output filter components are approximated by a second IIR approximation having a corresponding second output IIR order.

22. A digital signal processor according to claim 20, wherein each of the input filter components is associated with a corresponding output filter component in the first plurality of output filter component to render a first system response y₁(n) from an input signal x(n) according to
$${y}_{1} ( n ) = {\sum }_{p = 0}^{P - 1} {\sum }_{m = 0}^{M - 1} {v}_{m}^{p} {σ}_{m} {u}_{m}^{T} x ( n - pN ) ;$$
and wherein each of the input filters is further associated with a corresponding output filter in the second plurality of output filter components to render a second system response y₂(n) from the input signal according to
$${Y}_{2} ( n ) = {\sum }_{p = 0}^{P - 1} {\sum }_{m = 0}^{M - 1} {z}_{m}^{p} {σ}_{m} {u}_{m}^{T} x ( n - pN ) .$$

23. A digital signal processor according to claim 17, wherein the input IIR order differs from the output IIR order.

24. A digital signal processor according to claim 22, wherein the input IIR order differs from either or both of the first output IIR order and the second output IIR order.
